(19) United States
(12) Patent Application Publication
(10) Pub. No.: US 2007/0137822 A1
(43) Pub. Date: Jun. 21, 2007

(54) System and method of controlled acceleration indexing in materials handling

(76) Inventor: Henson C. Ong, Waterbury, CT (US)

Correspondence Address: Pitney Bowes Inc.;Intellectual Property & Technology Law Department, 35 Waterview Drive, P.O. Box 3000, Shelton, CT, 06484, US

(21) Appl. No.: 11/303,762

(22) Filed: Dec. 16, 2005

(51) Int. Cl. B26D 5/00

(52) U.S. Cl. 162/194; 162/193; 83/396

(57) ABSTRACT

A paper web is moved from an upstream source by a transport mechanism, and is cut into individual sheets of paper by a blade. The transport mechanism operates in a start-and-stop motion cycle to move the web intermittently. During the stop periods, the blade cuts the web. The transport mechanism includes a driving member, and also includes a driven member for performing a start-and-stop motion in response to simultaneous non-stop motion of the driving member. The driven member is arranged to cause the web to move to the blade, and each cutting occurs when the driven member is in a substantially stopped position. The interface between the driving member and the driven member is mechanical only.

### TECHNICAL FIELD

The present invention relates generally to paper processing, and more particularly to cutting sheets of paper.

### BACKGROUND OF THE INVENTION

It is well known for the input portion of an inserter system to include a mechanism for cutting a continuous sheet of paper (i.e. a paper web) into individual sheets of paper. See, for example, US Patent Application No. 2004/0221700 of Williams et al. which was filed Nov. 11, 2004 and which is incorporated herein by reference. As inserter technology has advanced over the years, inserters have been designed to operate at faster rates, but this has caused problems in connection with cutting a continuous sheet of documents into individual pages.

A guillotine cutter is used in conventional systems, to cut the paper web while it the paper stationary. A transport mechanism advances the paper web and stops it at prescribed positions. When the web is stopped, the guillotine cutter blade descends and cuts the web transversely. After the web is cut, and the guillotine cutter is raised, the web must be quickly accelerated and decelerated again to get the web in position for the next guillotine cut.

Mechanisms for feeding the web must be robust enough to handle extreme accelerations and decelerations, and must also be accurate enough that sheets are consistently cut at the desired positions. In typical prior art arrangement, the transport mechanism is comprised of servo motors that are electronically controlled to stop and start in the required positions.

While the servo motor solution has been found to be acceptable under a wide range of conditions, such a solution places limits on the speed of paper cutting, the accuracy of paper cutting, and on the lifetime of paper cutting equipment. New paper cutting technology is needed for inserter systems, in order to achieve similar or greater accuracy, in order to reduce wear that eventually destroys expensive servo motor mechanisms, and in order to simplify control of the system.

Typically, a continuous web cutter is used to cut a continuous web of material into cut sheets, and provide the cut sheets to a sheet accumulator, where the accumulated sheets are moved to an insertion station in a mass mailing inserting system. In a typical web cutter, a continuous web of material with sprocket holes on both sides of the web is fed from a fanfold stack into the web cutter. The web cutter has a tractor with pins or a pair of moving belts with sprockets to move the web forward toward a guillotine cutting module for cutting the web cross-wise into separate sheets. Perforations are provided on each side of the web so that the sprocket hole sections of the web can be removed from the sheets prior to moving the cut sheets to other components of the mailing inserting system. In particular, some continuous web cutters are used to feed two webs of material linked by a center perforation. In the cutter, a splitter is used to split the linked webs into two separate web portions before the linked webs are simultaneously cut by the cutting module into two cut sheets.

In a feed cycle, the paper is advanced past the blade of the guillotine cutting module by a distance equal to the length of the cut sheet, and is then stopped. In a cut cycle, the blade lowers to shear off the sheet of paper, and then withdraws from the paper. As soon as the blade withdraws from the paper path, the next feed cycle begins. The feed and cut cycles are carried out in such an alternate fashion over the entire operation.

In some web cutters, it is desirable to achieve a cutting rate of 25,000 cuts per hour or more, for example. This means that the web cutter has a feed/cut cycle of 144 ms. Typically the length of the cut sheet is 11 inches (27.94 cm). If the time to complete a cut cycle is about 34 ms, then the total time in a feed cycle is 110 ms (i.e. 144 minus 34). This means that the web must be accelerated from a stop position to a predetermined velocity and then decelerated in order to stop again within 110 ms. The acceleration and deceleration action of the tractor causes the paper web immediately upstream of the tractor to whip up and down uncontrollably. If the whipping motion is severe, the web may break. As the cutting rate increases, the problem becomes more acute.

Lorenzo (U.S. Pat. No. 5,768,959) discloses a web cutter wherein two separate modules are used to take in a web from upstream: a slitter module for slitting the web into two web portions so as to allow a cutter module to separately cut the web portions into sheets. Like Williams, Lorenzo used clutch/brake motors and servos to accelerate the paper material, then decelerate it to a stop at the present increment. However, clutch and brake systems are prone to slippage, and both clutch/brake and servos are subject to inertial factors, timing issues and also hysteresis factors, all of which contribute to positional inaccuracies.

### SUMMARY OF THE INVENTION

The present invention provides a mechanical substitute for the usual servo-driven start-and-stop motion of the paper web. Instead of using servo motors to control the starting and stopping, that is instead controlled mechanically, during cutting operations. A fixed or variable indexing mechanism is positioned between the motor and the rollers that roll the paper web. This indexing mechanism is tolerant of motor positional inaccuracies in both start and stop timing, as well as location inaccuracies, while additionally maintaining a controlled index increment that is inherently precise.

The paper web is moved from an upstream source by a transport mechanism, and is cut into individual sheets of paper by a blade. The transport mechanism operates in a start-and-stop motion cycle to move the web intermittently. During the stop periods, the blade cuts the web. The transport mechanism includes a driving member, and also includes a driven member that performs a start-and-stop motion in response to simultaneous non-stop motion of the driving member. The driven member is arranged to cause the web to move to the blade, and each cutting occurs when the driven member is in a substantially stopped position. The interface between the driving member and the driven member is mechanical only.

This can be accomplished by using a fixed or variable profile Geneva drive mechanism coupled with a closed loop motor control system, motor and sensors. The acceleration and deceleration profile can be varied by employing a transmission. The motor is coupled either directly with the primary stage engagement mechanism or through a flywheel and clutch system. The engagement between primary power input stage and the secondary indexing stage is accomplished through mechanical, electromechanical, electromagnetic, magnetic, pneumatic or hydraulic coupling. The fixed or variable profile Geneva drive mechanism, coupled with a closed loop motor control system, motor and sensors for indexing continuous bulk paper in accurate controlled increments, allows increased speed, accuracy, and longevity of the paper cutting device.

The angular velocity of a Geneva driving member determines the duration between cuttings. A transmission situated between the Geneva driven member and the paper web determines how fast paper is fed. Thus, the transmission can be used to alter the size of the individual sheets of paper that are produced by the cutter.

The use of a secondary stage fixed or variable indexing mechanism allows for motor positional inaccuracies in both start and stop timing, as well as location, while maintaining a controlled index increment that is inherently precise. The secondary stage isolates motor inaccuracies from the final motion profile.

The motor is coupled either directly with the primary stage engagement mechanism, or through a flywheel and clutch system. The engagement between the primary power input stage and the secondary indexing stage is accomplished through mechanical, electromechanical, electromagnetic, magnetic, pneumatic or hydraulic coupling. The acceleration/deceleration profile is either fixed in process or variable. This type of arrangement provides greater tolerance for motor positional errors and/or drift. Increased isolation of inertial factors prevents them from affecting desired the motion profile, be they inherent mechanical inertia factors or factors related to inertia of the material being conveyed/indexed. This invention also presents the possibility of reduction in the motor power requirement, increased throughput, and reduction in mechanism complexity. A gear mechanism eliminates complexity from the software and electronics, and provides a robust system without sacrificing accuracy of positioning.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 shows a typical prior art arrangement for feeding a paper web into a cutter.

FIG. 2 shows a transport mechanism according to the present invention, at an initial engagement phase.

FIG. 3 shows a transport mechanism according to the present invention, at a mid-acceleration phase.

FIG. 4 shows a transport mechanism according to the present invention, at a deceleration and exit phase.

FIG. 5 shows a transport mechanism according to the present invention, at an idle phase.

FIG. 6 shows a transport mechanism according to the present invention, at a deceleration and exit phase, and having two driving pins instead of one.

FIG. 7 shows a transport mechanism according to the present invention, at an idle phase, with three driving pins, and with a transmission.

FIG. 8 is a flow chart illustrating a method according to an embodiment of the present invention.

### BEST MODE FOR CARRYING OUT THE INVENTION

The present invention is a material conveyance indexing system whereby predefined increments of motion can be derived. It consists of two basic stages: the primary motivator and the secondary indexing mechanism. The primary motivator consists of a closed loop sensor/encoder controlled component, which provides the power to drive the secondary indexing mechanism. A typical implementation is an engagement system driven by a servomotor and/or a flywheel coupled to a clutch/brake system. The primary motivator incorporates a method by which it engages the secondary indexing mechanism.

The engaged motion profile could be either fixed or adjustable, allowing for a secondary modifier to the acceleration/deceleration profile independent of the angular velocity of the primary motivator. In its simplest embodiment, this invention consists of a slotted wheel that is intermittently engaged by a driving pin through an arc of motion. Each 360 degree rotation of the primary motivator causes the secondary mechanisms to index by a fixed 90 degree arc. This ratio could be changed depending on the number of engagement points provided in the primary.

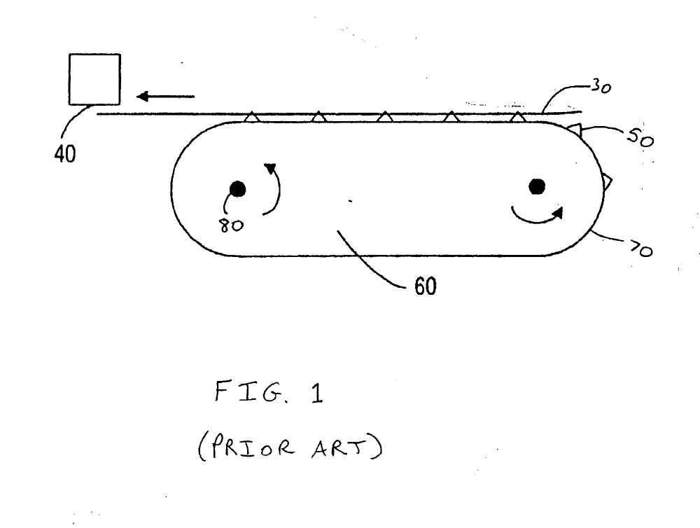

FIG. 1 shows a typical prior art arrangement for feeding a paper web 30 into a blade 40. This arrangement can also be used in conjunction with the present invention. A tractor 60 includes a sprocket belt 70 having sprockets 50. The paper web 30 has sprocket holes that facilitate movement of the paper web by the tractor 60. Of course, it is also possible to use wheels and/or rollers to move the web, instead of using a tractor, in which case it is unnecessary to provide sprocket holes in the paper web. The present invention provides an improved way to drive the axle 80.

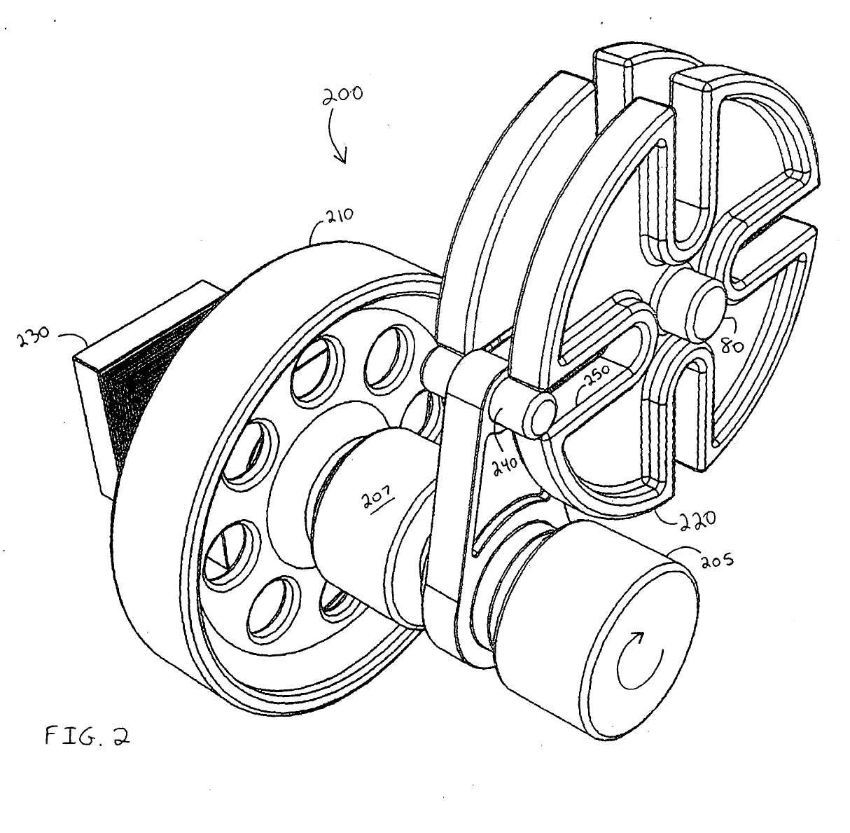

The axle 80 can also be seen in FIG. 2, which details a transport mechanism 200 according to an embodiment of the present invention at an initial engagement phase. The primary motivator 205 is a driving member that drives a driven member 220 which is a slotted wheel that acts as a secondary indexing mechanism, in the sense that it indicates locations where the paper web will be cut and adjusts the paper web to be cut in those locations. A clutch 207 and flywheel 210 are not essential to the invention, but they do make it possible to stop the primary motivator 205 even while the motor 230 continues to run. A driving pin 240 engages a slot 250 of the driven member 220, and that starts the driven member rotating.

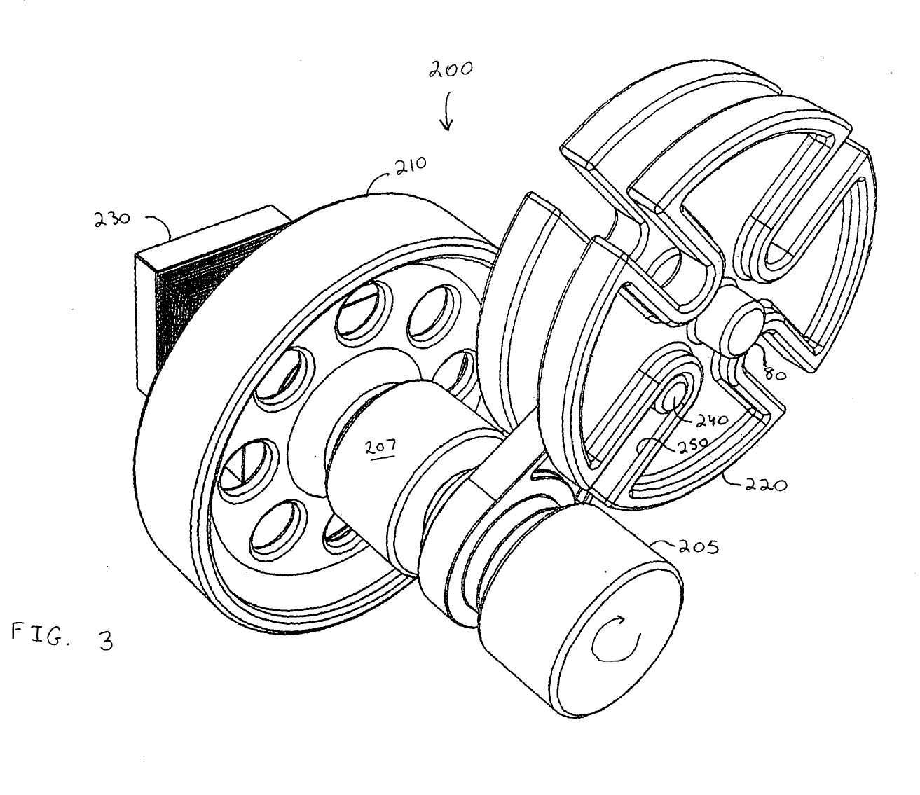

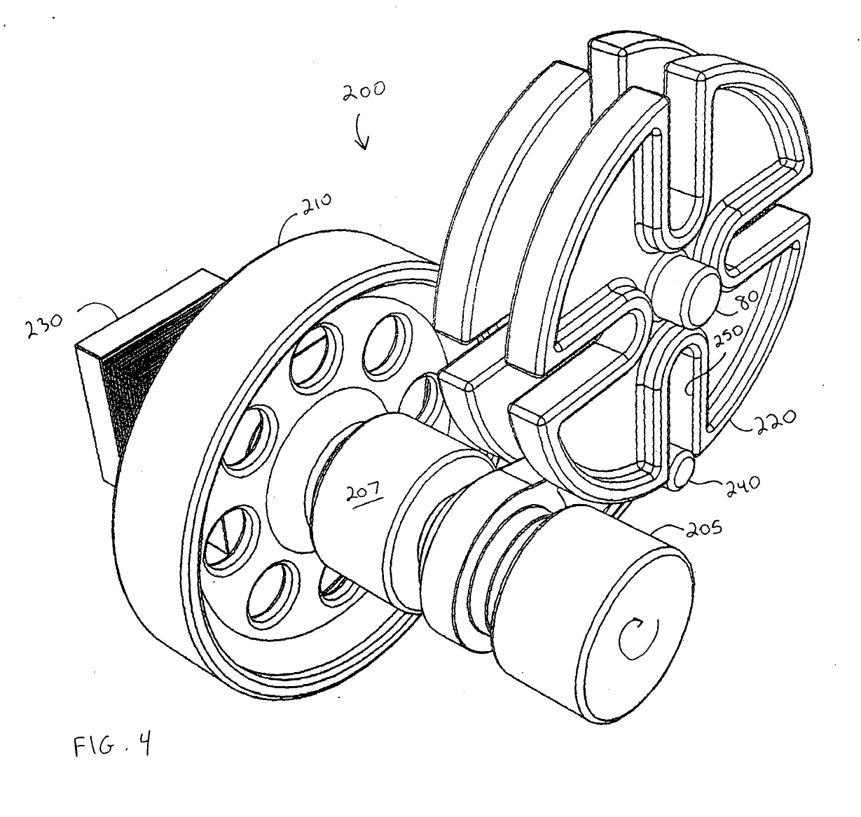

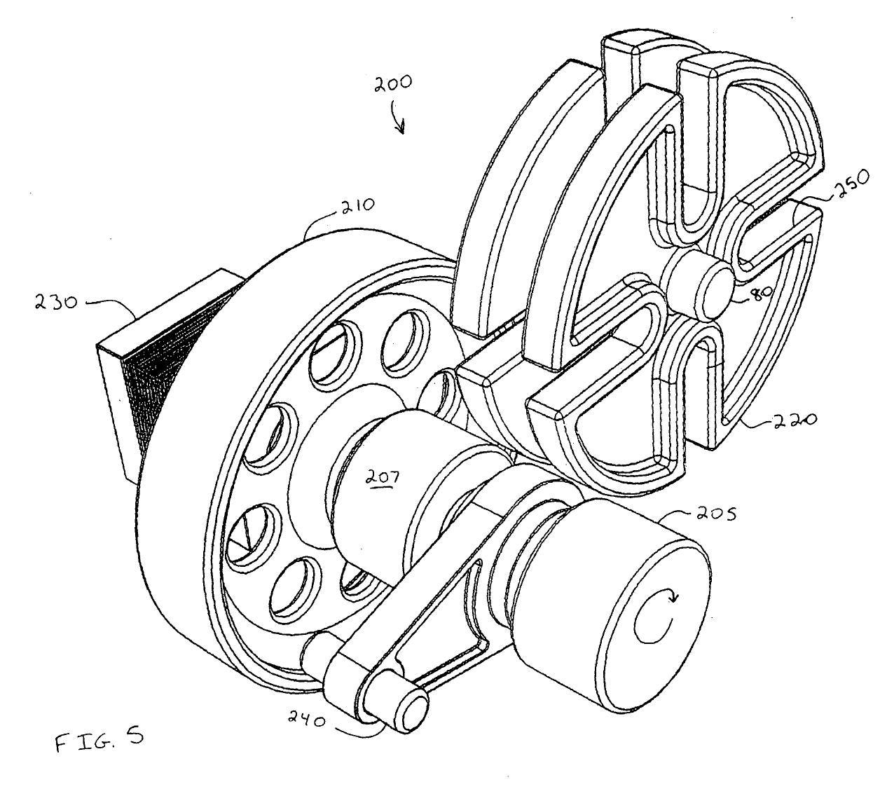

FIG. 3 shows a mid-acceleration phase of the device shown in FIG. 2, with the pin 240 fully engaged with the driven member 220 so that the driven member is rotating and causing the axle 80 to rotate, which causes the paper web to move as already shown in FIG. 1. FIG. 4 shows a deceleration and exit phase of the device already shown in FIGS. 2 and 3; the driving pin 240 is exiting the slot 250, and therefore the driven member 220 and axle 80 are slowing down. FIG. 5 shows the device in an idle phase, with the driving pin 240 fully disengaged from the driven member 220. During this idle phase, the driven member 220 and the axle 80 are motionless, with zero angular velocity, even while the driving pin 220 and the primary motivator 205 continue to move at uniform non-zero angular velocity. It is during this idle phase that that paper web 30 is stopped and the cutter 40 slices the paper, as shown in FIG. 1.

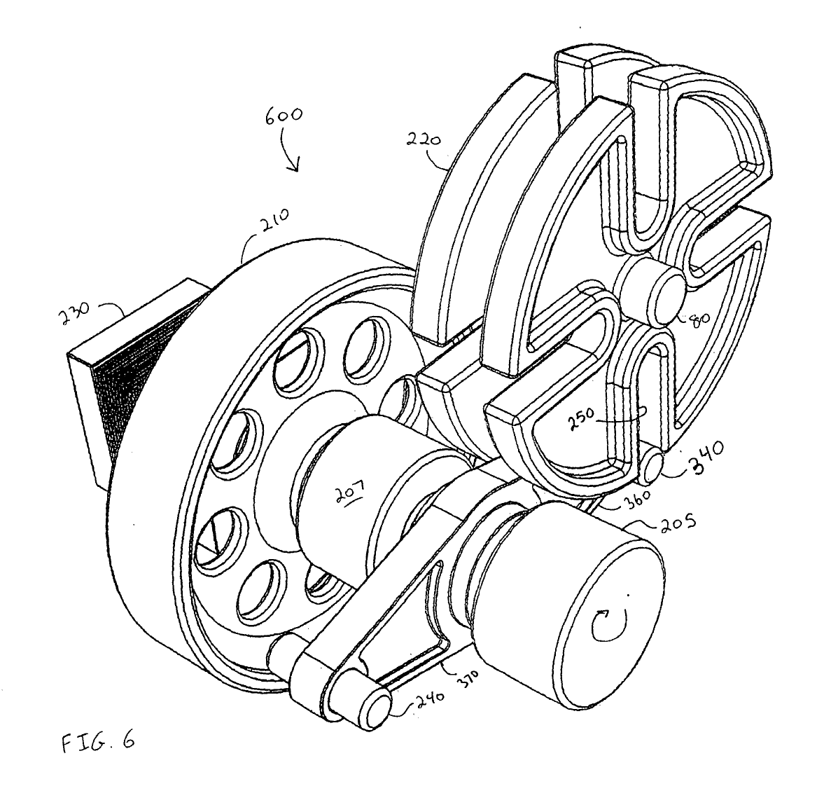

FIG. 6 is the same as FIG. 4, except that in this transport mechanism 600 there is a second driving pin 340. The arrangement of FIG. 6 may be preferable to the single driving pin of FIG. 4 because, for example, the weight of the two arms 360 and 370 will be evenly balanced in the arrangement of FIG. 6.

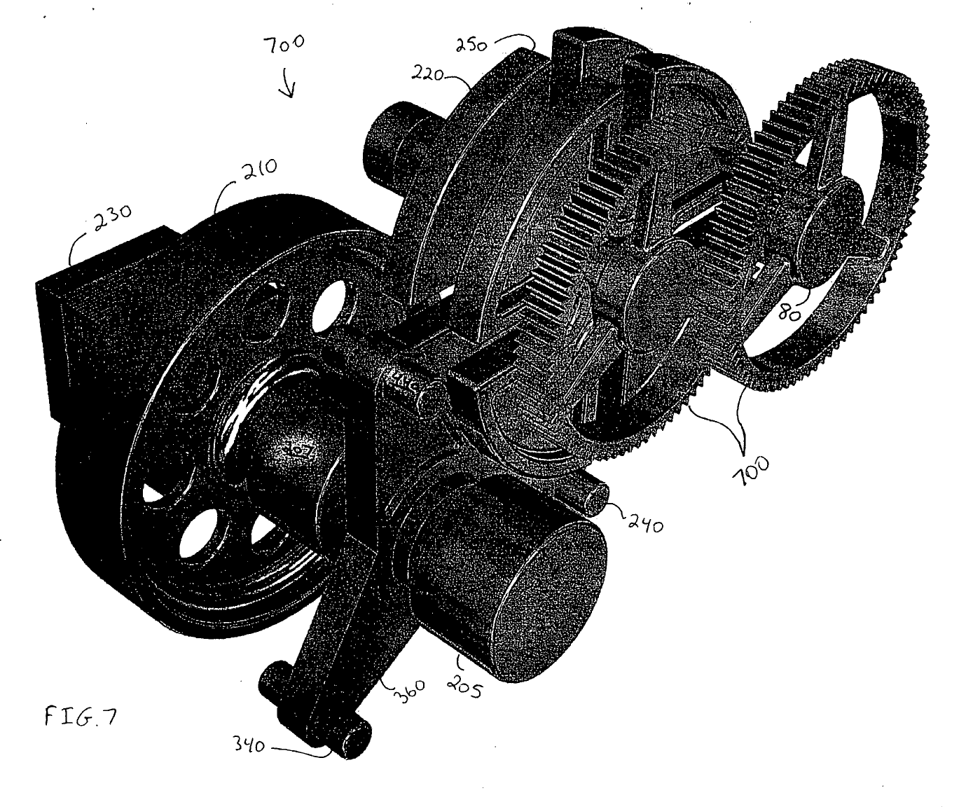

FIG. 7 is similar to FIG. 6, except that in this transport mechanism 700 there is a third driving pin 440. Also, FIG. 7 shows a transmission 700 situated between the driven member 220 and the axle 80 that drives the paper web. When a transmission 700 is used, the driving member 205 can rotate with uniform angular velocity while the transmission can be used to alter the angular velocity of the axle 80. In this way, the duration between stops of the driven member 200 will remain constant, but the speed of the paper web will be variable, so the cutter will cut individual sheets having a selectable length. It is important to realize that the location of the transmission is very important here. If the transmission were instead situated between the motor 230 and the driving member 205, then that would merely change the rapidity with which the device cuts sheets of paper, without altering the size of each sheet that is cut.

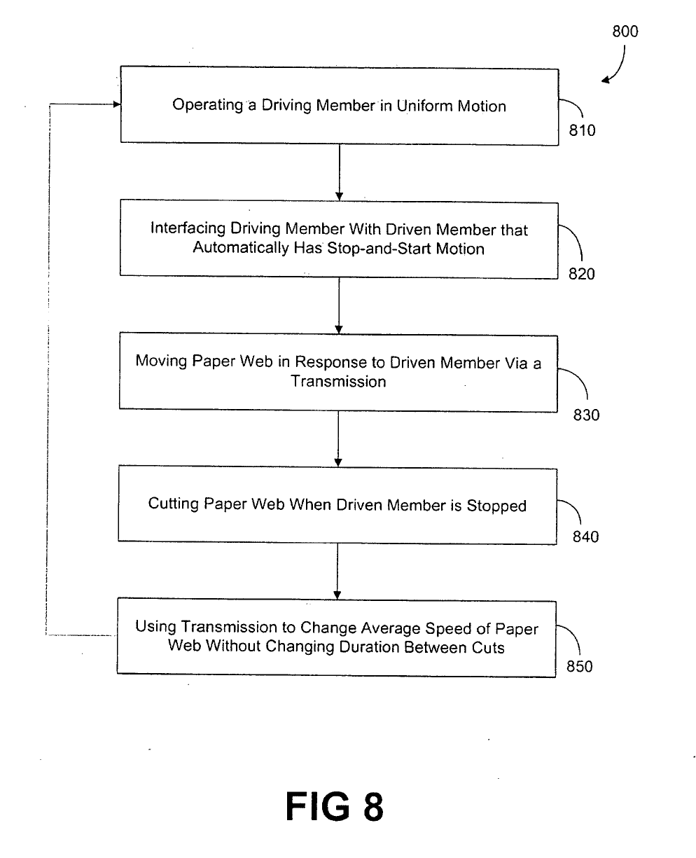

FIG. 8 is a flow chart illustrating a method 800 according to an embodiment of the present invention. A driving member is operated 810 in uniform motion. The driving member is interfaced 820 with a driven member that automatically has stop and start motion. Then, a paper web is moved 830 in response to the driven member, via a transmission. Subsequently, the paper web is cut 840 when the driven member is stopped. A transmission is then used 850 to change the average speed of the paper web, without changing the duration between cuts.

Various different embodiments of the present invention are possible, as will be understood be a person skilled in the art. Examples of a few such embodiments will now be briefly described. A linear or other non-circular geometry can be used for the primary mover and/or the secondary mechanisms, instead of using an angular primary mover. Also, a magnetic or electromagnetic engagement can be used between the primary motivator and the secondary mechanisms, instead of using a mechanical engagement. When an angular primary mover is used, the angular increments can be other than 90 degrees. The contact point between the primary mover and the secondary mechanisms can be articulated and/or retractable. The primary mover can be operated directly by a servo motor, or instead can be operated indirectly, via a flywheel. The device can have a static engagement profile, or the engagement profile can be adjustable by using a transmission or the like. The transmission can be a controlled variable transmission mechanism, or a preset manual transmission for linkage between the secondary and the final motion system. Also, a 90 degree pinch-type power takeoff mechanism can be utilize between the secondary and final-motion systems. Multiple primaries can be driven by a single secondary, or multiple secondaries can be driven by a single primary.

It is to be understood that the present figures, and the accompanying narrative discussions of embodiments, do not purport to be completely rigorous treatments of the methods and systems under consideration. A person skilled in the art will understand that the steps of the present application represent general cause-and-effect relationships that do not exclude intermediate interactions of various types, and will further understand that the various structures described in this application can be implemented by a variety of different combinations of hardware and/or software, and in various configurations which need not be further elaborated herein.

What is claimed is:

1. A system for moving a paper web from an upstream source, and for cutting the paper web into sheets, the system comprising:
a blade for cutting the web into the sheets; and
a transport mechanism for operating in a start-and-stop motion cycle to move the web so as to allow the blade to cut the web during stops;
wherein the transport mechanism includes a driving member, and also includes a driven member for performing a start-and-stop motion in response to non-stop motion of the driving member, the driven member being arranged to cause the web to move to the blade; and
wherein each of the stops occurs when the driven member is in a substantially stopped position.

2. The system of claim 1, wherein the driving member and the driven member have a mechanical interface via which the non-stop motion of the driving member automatically causes the start-and-stop motion of the driven member.

3. The system of claim 1, wherein the driving member is a Geneva driving member, wherein the driven member is a Geneva driven member, and wherein the mechanical interface includes a driving pin of the Geneva driving member and a slot of the Geneva driven member.

4. The system of claim 1, wherein the driving member rotates at substantially constant speed, whereby cuttings by the blade are separated by a substantially constant duration.

5. The system of claim 1, wherein the transport mechanism further comprises a transmission device driven by the driven member, for moving the paper web to the web cutter.

6. The system of claim 4, wherein the transport mechanism further comprises a transmission device driven by the driven member, for moving the paper web to the web cutter,
whereby the transmission device changes the acceleration and deceleration profile of the paper web, allowing the size of the sheets to change.

7. A web cutting device for moving a paper web from an upstream source, and for cutting the paper web into sheets, the system comprising:
a driving member;
a driven member intermittently driven by the driving member, the driven member being arranged so as to move the paper web; and
a blade activated when the paper web and the driven member are substantially stopped, and while the driving member continues in motion.

8. The web cutting device of claim 7, wherein the driving member and the driven member are rotatably arranged around respective axles, and wherein the driving member and the driven member have a mechanical interface via which non-stop rotation of the driving member automatically causes start-and-stop rotation of the driven member

9. The web cutting device of claim 7, wherein the driving member is a Geneva driving member, and wherein the driven member is a Geneva driven member.

10. The web cutting device of claim 7, wherein the driving member rotates at substantially constant speed, whereby cuttings by the blade are separated by a substantially constant duration.

11. The web cutting device of claim 10, wherein the web cutting device is adjustable so as to alter an acceleration and deceleration profile of the paper web, thereby allowing the sheets to have an altered size.

12. A method for moving a paper web from an upstream source, and for cutting the paper web into sheets, the method comprising:
operating a driving member in substantially uniform motion;
interfacing the driving member with a driven member that automatically is driven to move in a stop-and-start manner;
moving the paper web in response to the driven member; and
cutting the paper web when the driven member and the paper web are stopped.

13. The method of claim 12, wherein the step of moving the paper in response to the driven member is performed via a transmission.

14. The method of claim 13, further comprising the step of using the transmission to alter an acceleration and deceleration profile of the paper web, thereby altering the size of the sheets.

15. The method of claim 13, further comprising the step of using the transmission to alter an average speed of the paper web without altering a duration between the cuttings, thereby altering the size of the sheets.

16. The method of claim 12, wherein the duration between cuttings is substantially determined by the uniform motion of the driving member, but speed and acceleration of the paper web are modifiable by a transmission that is directly or indirectly driven by the driving member.
